(19) United States
(12) Patent Application Publication
(10) Pub. No.: US 2024/0295285 A1
(43) Pub. Date: Sep. 5, 2024

(54) MULTI-AXIS NANOPOSITIONER FLEXURE STAGE WITH COARSE AND FINE ADJUSTMENT

(71) Applicant: Thorlabs, Inc.

(72) Inventors: Keith Dhese, Milton (GB); Dave Grimwade, Burwell (GB); Lina Arauz, Milton (GB); Mate Vida, Cambridge (GB)

(21) Appl. No.: 18/593,460

(22) Filed: Mar. 1, 2024

Related U.S. Application Data
(60) Provisional application No. 63/449,763, filed on Mar. 3, 2023.

(51) Int. Cl. F16M 11/18; F16M 11/04; F16M 11/12

(52) U.S. Cl. CPC F16M 11/18; F16M 11/043; F16M 11/12

(57) ABSTRACT

A multi-axis positioner including: a base; a platform; and an arrangement of a plurality of actuators mounted onto the base; wherein the arrangement of the plurality of actuators are coupled to the platform via a plurality of monolithic flexures such that the arrangement of the plurality of actuators moves the platform relative to the base in a plurality of axes of motion; wherein each of the plurality of actuators includes a coarse travel actuation mechanism coupled directly with a fine travel actuation mechanism in a corresponding axis of motion of the arrangement of the plurality of actuators; wherein the fine travel actuation mechanism has a higher travel resolution than that of the coarse travel actuation mechanism.

### CROSS REFERENCE TO RELATED APPLICATIONS

This application claims the benefit of U.S. Provisional Patent Application No. 63/449,763 filed on Mar. 3, 2023. The disclosure of U.S. Provisional Patent Application No. 63/449,763 is hereby incorporated by reference.

### TECHNICAL FIELD

The present disclosure generally relates to positioning stages, and more particularly to a multi-axis nanopositioner flexure stage with coarse and fine adjustment.

### BACKGROUND

There exists a market need for a positioner mechanism with both coarse travel and sufficiently long fine travel for nanopositioning applications. The stage's ability to position objects at the nanometer level can be used in research labs or other industrial applications that demand high levels of performance in precision positioning, for example, fiber coupling, microscopy, life science, biotechnology, etc.

Products available in the marketplace have either only coarse or fine travel, or they have a multi axis flexure and rely on external piezo drive(s) to provide the fine translation(s).

Existing solutions utilize the same flexure mechanism to achieve the motion in 3 axes. However, the piezo stacks are directly coupled to the tip of the actuator, therefore the fine piezo travel range was limited to the maximum displacement of the piezo stack. The maximum displacement is driven by the length and voltage of the piezo stack. The cost of piezo stacks increases greatly with length and fitting a stack with sufficient displacement to achieve the desired fine travel range would not be possible without significantly enlarging the footprint of the product. Moreover, some existing solutions include external piezo actuators. Although adding such external actuators increases the fine travel range of the stage by another 20μ, it also adds significant cost and footprint to the product. FIG. 1 shows an example of this conventional design with the external piezo actuators attached.

In view of the above shortcomings in the existing products, there is a long-felt need for a multi-axis flexure stage capable of both coarse and fine travel in all axes, within a relatively small footprint.

### SUMMARY

A mechanical amplifier with a lever mechanism is proposed in the present disclosure to overcome above issues and allow for sufficient fine travel range. For example, in one embodiment, over 80μ m of fine travel can be achieved. Furthermore, increasing the footprint of the embodiment would result in even larger fine travel of over 100μ. The amplifier can utilize any small actuator capable of fine resolution, such as a piezo actuator, voice coil, etc.

The present disclosure proposes a multi-axis flexure stage capable of both coarse and fine travel in all axes. The stage comprises a coarse and fine travel actuation mechanism coupled together and a flexure mechanism that transmits the actuation to the moving world. The coarse travel can be achieved by a manual or motorized actuator, whereas the fine travel is provided by an alternative actuator solution capable of fine resolution with a mechanical amplifier. An embodiment of the present disclosure can be used in both an open and closed loop feedback arrangement. According to one embodiment, the coupling of a mechanical amplifier to the coarse travel drive achieves a greatly improved fine travel range compared to the previous solution in the same product volume.

An embodiment of the present disclosure provides a multi-axis positioner including: a base; a platform; and an arrangement of a plurality of actuators mounted onto the base; wherein the arrangement of the plurality of actuators are coupled to the platform via a plurality of monolithic flexures such that the arrangement of the plurality of actuators moves the platform relative to the base in a plurality of axes of motion; wherein each of the plurality of actuators includes a coarse travel actuation mechanism coupled directly with a fine travel actuation mechanism in a corresponding axis of motion of the arrangement of the plurality of actuators; wherein the fine travel actuation mechanism has a higher travel resolution than that of the coarse travel actuation mechanism.

### BRIEF DESCRIPTION OF THE DRAWINGS

FIG. 1 is a diagram of an existing positioner design with external piezo actuators attached.

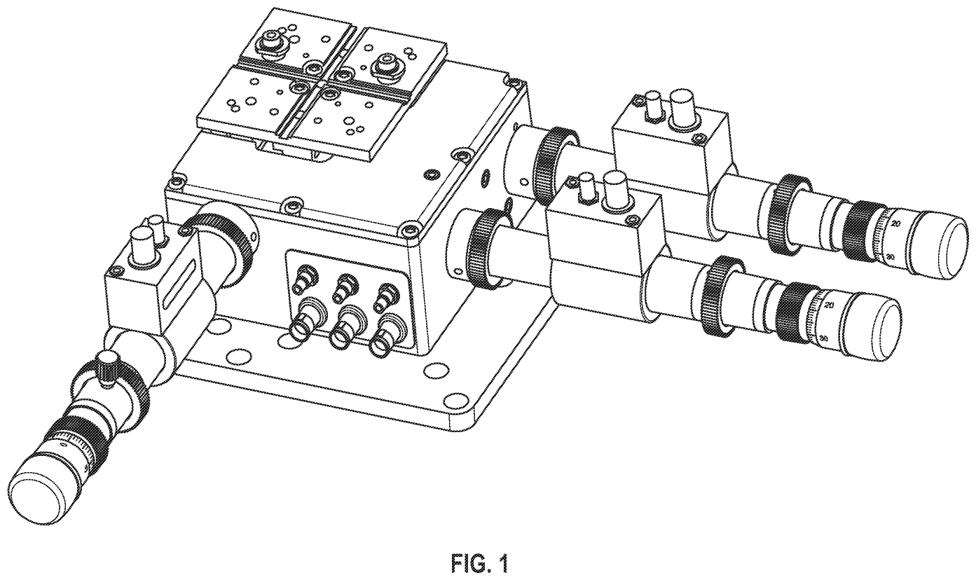

FIG. 2 is a block diagram of a positioner according to one embodiment of the present disclosure.

FIG. 3 shows the components of a positioner according to one embodiment of the present disclosure.

FIG. 4 is a Y-axis view of a positioner according to one embodiment of the present disclosure.

FIG. 5A shows a piezo element in a relaxed state and FIG. 5B shows the piezo element in an expanded state according to one embodiment of the present disclosure.

FIG. 6 shows the respective graphs of drive voltage vs. stage travel for an existing positioner and a positioner according to one embodiment of the present disclosure.

FIG. 7A shows a piezo drive mechanism in an existing positioner and FIG. 7B shows a piezo amplifier in a positioner according to one embodiment of the present disclosure.

FIG. 8 shows a piezo amplifier in a 6-axis stage according to one embodiment of the present disclosure.

### DETAILED DESCRIPTION

The description of illustrative embodiments according to principles of the present disclosure is intended to be read in connection with the accompanying drawings, which are to be considered part of the entire written description. In the description of embodiments of the disclosure disclosed herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the exemplified embodiments. Accordingly, the disclosure expressly should not be limited to such exemplary embodiments illustrating some possible non-limiting combination of features that may exist alone or in other combinations of features; the scope of the disclosure being defined by the claims appended hereto.

This disclosure describes the best mode or modes of practicing the disclosure as presently contemplated. This description is not intended to be understood in a limiting sense, but provides an example of the disclosure presented solely for illustrative purposes by reference to the accompanying drawings to advise one of ordinary skill in the art of the advantages and construction of the disclosure. In the various views of the drawings, like reference characters designate like or similar parts.

It is important to note that the embodiments disclosed are only examples of the many advantageous uses of the innovative teachings herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality.

The coarse travel mechanism can be any suitable actuator that provides the required travel range and suitable for a specific operation environment. For example, the coarse travel mechanism can be a manual operated micrometer adjustment screw, or a motorized actuator, etc.

The fine travel mechanism can be any suitable actuator that provides the required travel range and the required fine travel resolution. In one particular embodiment described in the present disclosure, fine travel mechanism uses a compact piezo stack, whose dimensions can be varied by an application of a voltage.

Note that in a traditional piezo actuator design, a large number of piezo elements are stacked together in order to achieve a required long travel range. However, this would increase the required footprint of the piezo actuator.

As mentioned before, there is a great interest in the industry to achieve a sufficiently long fine, precise travel, maintaining the same amount of coarse travel in each axis of travel and the same overall product footprint. If the footprint of the product is increased, even larger fine displacement can be achieved.

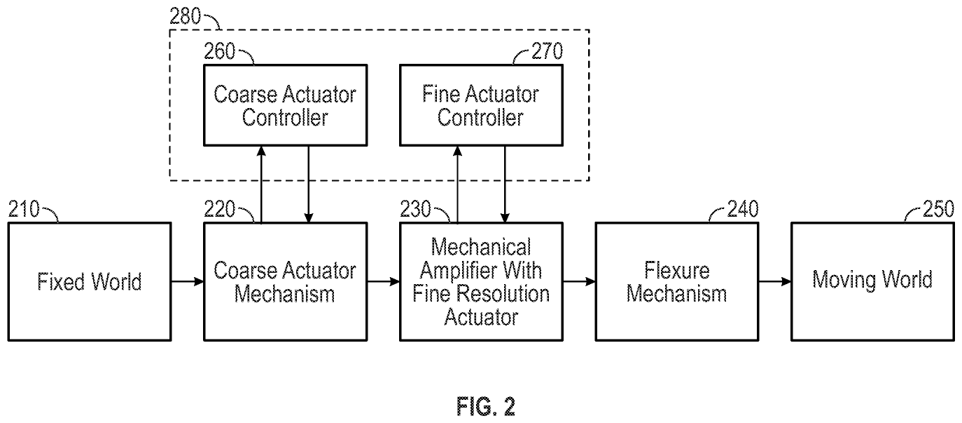

FIG. 2 is a block diagram of components of a multi-axis positioner according to an embodiment of the present disclosure. The fixed world 210 is generally a base that is fixed in a setup. The base may have mounts configured for receiving a plurality of actuators. The moving world 250 is generally a platform that has one or more surfaces for attaching a sample or device to be positioned. The actuator includes a coarse travel actuation mechanism 220 coupled directly a fine travel actuation mechanism 230. The flexure mechanisms 240 are configured to translate respective travels from the actuators to the platform (moving world). In one embodiment, the fine travel actuation mechanism is mechanical amplifier which provides long and precision travel actuations.

In one embodiment, the multi-axis positioner includes a feedback mechanism. The feedback can be used both in an open and closed loop arrangement. The closed loop feedback mechanism can be the following: capacitive feedback, strain gauge mechanism, optical feedback, magnetic feedback, or electrical resistance feedback. In one embodiment, one or more of the fine and coarse travel mechanisms can be controlled by their respective controllers 270, 260, or by a single controller 280 having separate fine and coarse control functions. The controller can be integrated into the device or can be a standalone unit. Furthermore, with the feedback mechanism, the controller can control one or more of the fine and coarse travel mechanisms based on the feedback in real time.

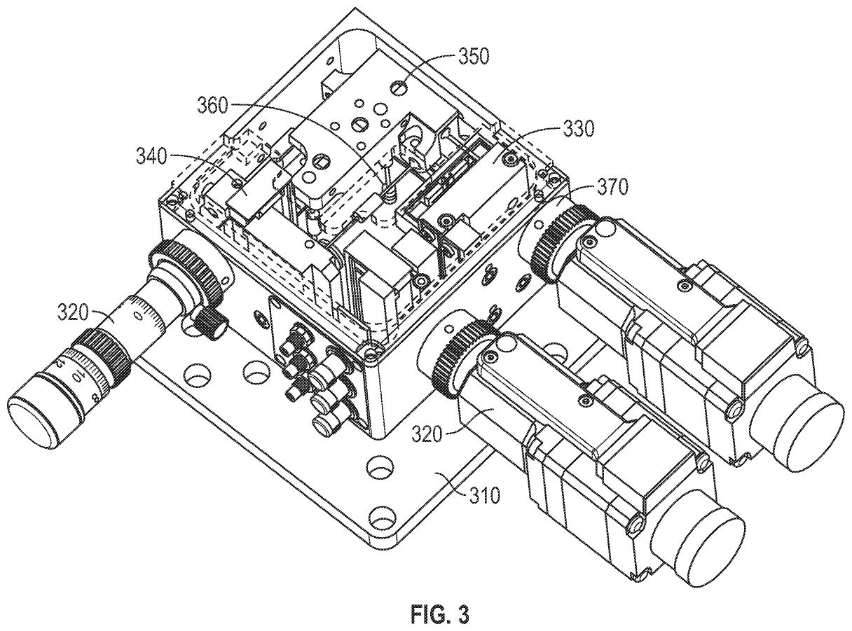

FIG. 3 is a 3-axis arrangement for a positioner according to one example embodiment. The positioner includes a base plate 310 equipped with mounting bushes 370 to which the external actuators 320 are attached that provides the coarse movement. The coarse actuators can be a manual driver or a stepper motor for coarse position adjustment. Also shown are the internal levers 330 on which the piezo stacks are mounted. The piezo fine travel actuator 340 provides the extended fine travel for accurate position adjustment. The monolithic titanium flexures 360 connect the moving world 350 to the levers and allow movement of the moving world in 3 axes. In this embodiment the position feedback is achieved by a strain gauge, but in other embodiments it can be extended to any other feedback mechanism mentioned above, e.g., a potentiometer as an electrical resistance feedback mechanism. The unit has an external controller capable of both open and closed loop operation, but in other embodiments, the controller may be integrated into the positioner.

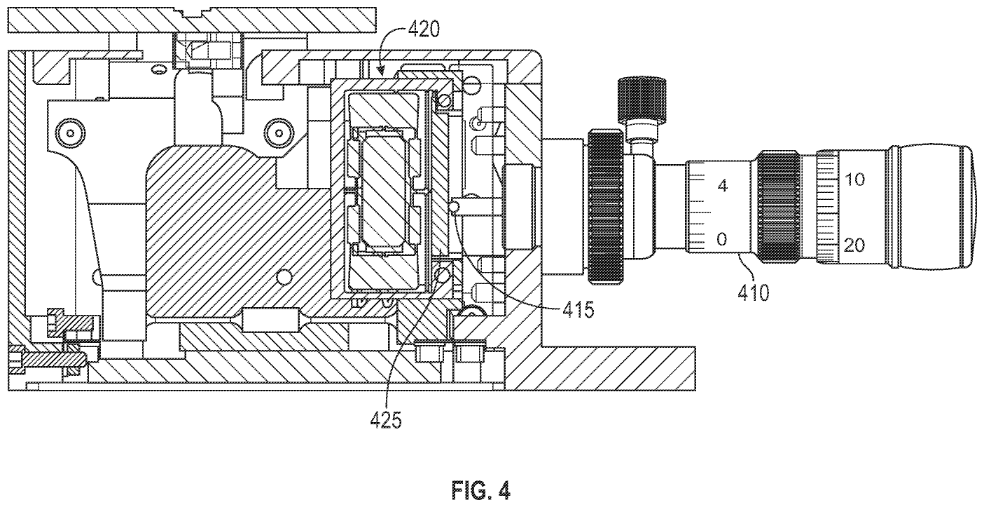

In one embodiment of the present disclosure, FIG. 4 shows how the coarse and fine travel is achieved on the Y-axis. The coarse actuator tip 410 acts directly on the lever of the fine travel piezo amplifier 420, which is attached rigidly to the Y-axis lever 425. Displacement of coarse travel actuator tip 415 translates the moving world in the Y-direction. The coarse actuator 410 being either a micrometer for manual movement or a motorized actuator (brushed or brushless DC motor, stepper motor, inertial drive, etc.) for automated movement. When the piezo stack is energized, the amplifier expands, further translating the moving world in the Y-direction giving fine resolution travel control.

Within the same embodiment, the same principle is also applied to the other axes of travel, each axis having a similar coarse and fine travel mechanism. In one embodiment, the combined coarse and fine travel in the X, Y and Z directions is transferred to the moving world by 6 monolithic flexures (2 flexures per axis for better stability) thereby facilitating movement in all 3 axes simultaneously.

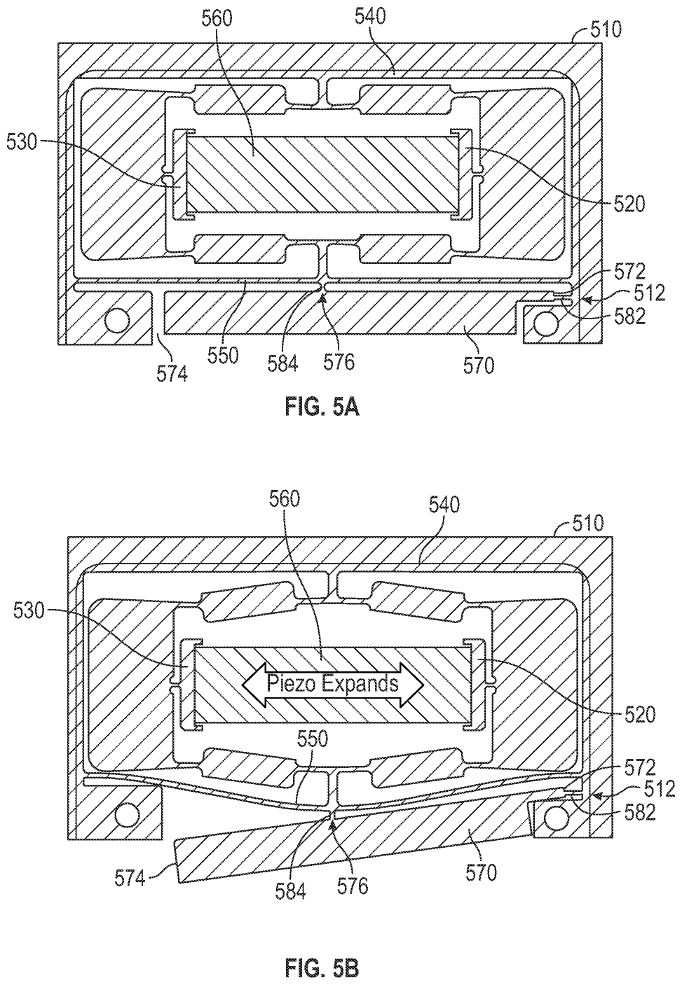

The working principle of the amplifier can be seen in FIGS. 5A and 5B in one example embodiment. Before energizing, the mechanism is at a neutral state as shown in FIG. 5A. As voltage is applied on the piezo stack, it expands, and the mechanism is deformed as shown on FIG. 5B.

In the present example embodiment of FIGS. 5A and 5B, the fine travel actuation mechanism includes a flexure frame with holes for mounting. The flexure frame 510 has various parts linked by flex hinges. In particular, there are two side walls 520, 530 that are coupled to respective two ends of a piezo stack 560. When the piezo stack expands/contracts, it pushes/pulls the sidewalls 520, 530. Through the flex hinges, the horizontal movement of the side walls causes a corresponding vertical movement by the top and bottom walls 540, 550. The rigid frame above the top wall limits the movement of the top wall and causes the vertical movement to largely manifest in the movement of the bottom wall 550. The mechanism also includes a lever bar 570 having a first end 572 and a second end 574. The first end 572 of the lever bar is linked to a fixed point 512 in the flexure frame via a flex hinge 582. This fixed point serves as a fulcrum of the lever. The bottom wall is coupled to the lever at a location 576 between the two ends of the lever bar via a flex hinge 584. Because a first distance between the first end and the coupled location is shorter than a second distance between the first end and the second end, when the bottom wall pushes/pulls the lever bar at the coupled location, the second end makes a corresponding vertical movement with an amplification factor equal to the ratio of the second distance to the first distance.

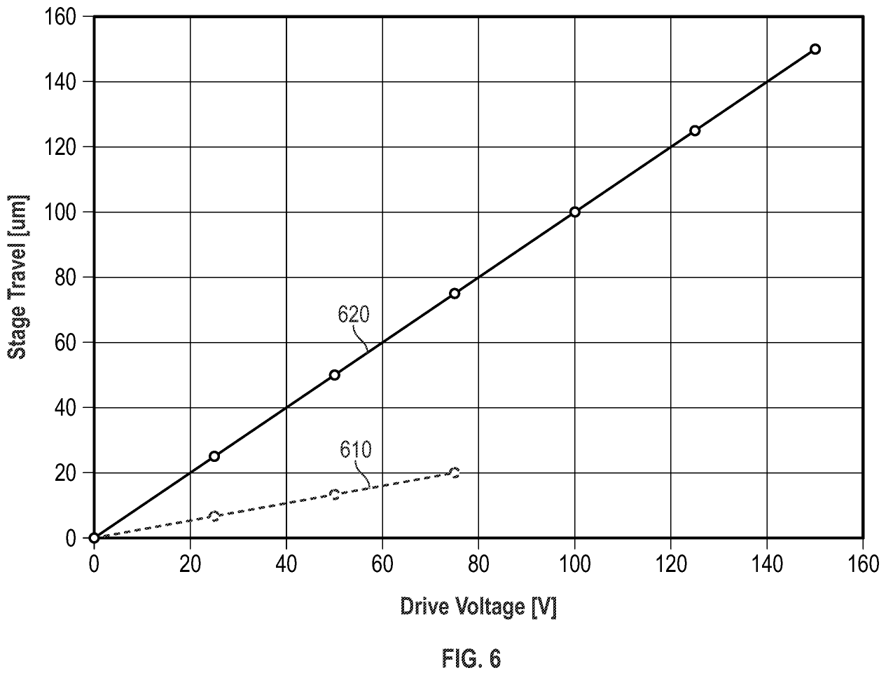

Because of the use of a mechanical amplifier according to an embodiment of the present disclosure, a large fine travel range can be realized. FIG. 6 shows a graph of drive voltage vs. stage travel for an existing positioner in conjunction with a graph of drive voltage vs. stage travel for a positioner according to one embodiment of the present disclosure. It can be seen from the plot 610 of the existing positioner and the plot 620 of the positioner according to the one embodiment of the present disclosure that the positioner according to the one embodiment has a much larger fine travel range than the existing positioner.

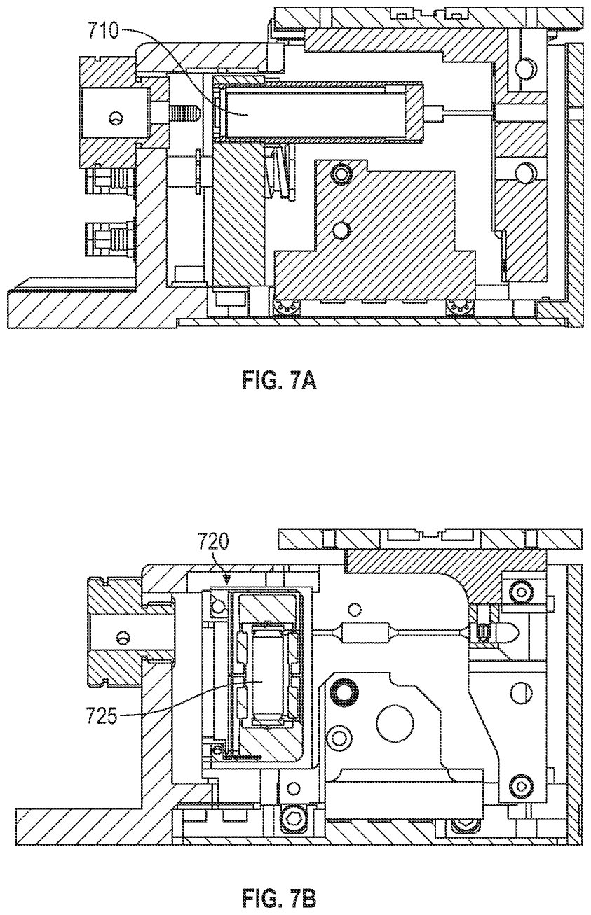

FIGS. 7A and 7B further illustrate the unique advantage of an embodiment of the present disclosure. FIG. 7A shows the piezo stack arrangement of an existing positioner. The fine movement of the stage is realized by the direct expansion/contraction of the piezo stack 710. However, in order to provide a desired long travel range, a large number of piezo elements are needed to achieve the required cumulated range, and thus results in a large footprint for the device. In contrast, FIG. 7B shows a smaller piezo stack arrangement according to an embodiment of the present disclosure. Because of the mechanical amplifier 720 employed in an embodiment, fewer piezo elements 725 are needed to provide the same or longer travel range than the existing design. Because of fewer piezo elements and the orientation of the stack in an embodiment, the footprint of the positioner is much smaller and compact than existing positioner.

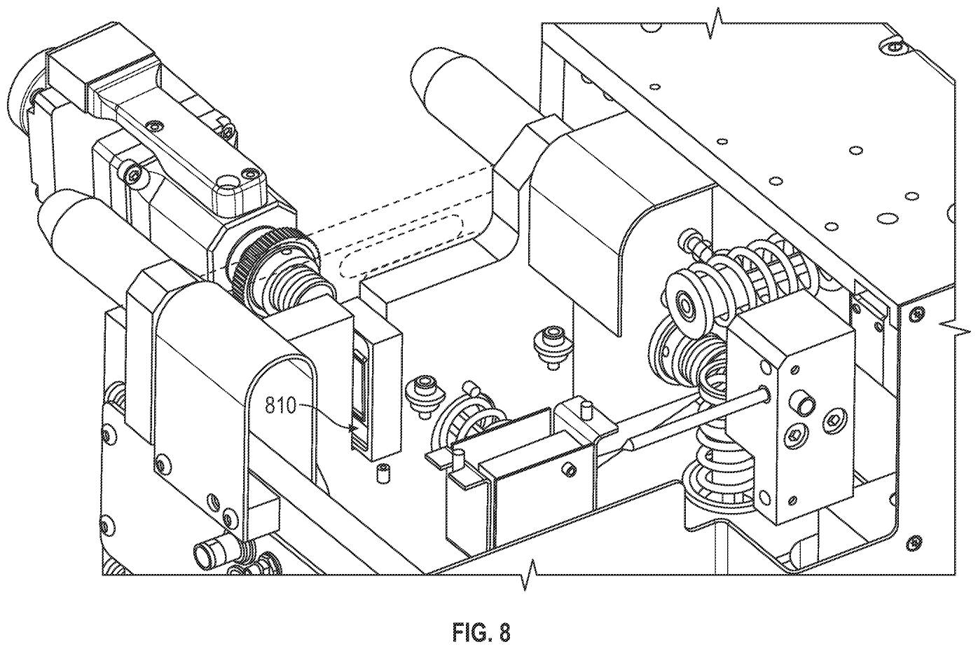

It is worth noting that the concept of coupling the fine and coarse travel and utilizing the fine travel amplification method described above it is not limited to a particular 3-axis embodiment, and it can be extended to any multi-axis arrangements. FIG. 8 shows the piezo amplifier 810 attached to the lever of the X-axis of a 6-axis stage. The working principle of the coupled fine and coarse translation in this design is the same as in the 3-axis embodiment. The micrometer screw actuator provides the coarse translation, and this coarse actuator is directly attached to the piezo amplifier. The piezo amplifier mechanism provides the fine translation in the axis of travel. Furthermore, the concept can be implemented not only in multiple axes of translation, but also rotations, e.g., roll, pitch and yaw. A similar amplified actuator can be used to create rotations with both coarse movement as well as fine adjustment.

While the present disclosure describes at some length and with some particularity with respect to the several described embodiments, it is not intended that it should be limited to any such particulars or embodiments or any particular embodiment, but it is to be construed so as to provide the broadest possible interpretation in view of the related art and, therefore, to effectively encompass various embodiments herein. Furthermore, the foregoing describes various embodiments foreseen by the inventor for which an enabling description was available, notwithstanding those modifications of the disclosure, not presently foreseen, may nonetheless represent equivalents thereto.

1. A multi-axis positioner comprising:
a base;
a platform movable relative to the base; and
an arrangement of a plurality of actuators mounted onto the base;
wherein the arrangement of the plurality of actuators are coupled to the platform via a plurality of monolithic flexures such that the arrangement of the plurality of actuators moves the platform relative to the base in a plurality of axes of motion;
wherein each of the plurality of actuators comprises a coarse travel actuation mechanism coupled directly with a fine travel actuation mechanism in a corresponding axis of motion of the arrangement of the plurality of actuators;
wherein the fine travel actuation mechanism has a higher travel resolution than that of the coarse travel actuation mechanism.

2. The multi-axis positioner of claim 1, wherein the fine travel actuation mechanism comprises:
a flexure frame having a first side wall, a second side wall, a top wall, a bottom wall, and a lever bar; and
a piezo stack, a first end and a second end of the piezo stack being coupled to the first side wall and second side wall respectively;
wherein the first side wall, second side wall, top wall and bottom wall are linked by flex hinges such that an expansion or contraction of the piezo stack in a horizontal direction generates a corresponding expansion or contraction of the bottom wall in a vertical direction;
wherein the lever bar has a first end and a second end, the first end of the lever bar being linked by a first flex hinge to a fixed location in the flexure frame, and a first location of the lever bar is linked by a second flex hinge to a corresponding location of the bottom wall, and
wherein a distance between the first end and first location of the lever bar is shorter than a distance between the first end and second end of the lever bar, such that the expansion or contraction of the bottom wall is amplified in the second end via a lever action.

3. The multi-axis positioner of claim 2, wherein the top wall is attached to a rigid frame which limits the movement of the top wall and causes a vertical movement resulted from the expansion or contraction of the piezo stack to largely manifest in a movement of the bottom wall.

4. The multi-axis positioner of claim 1, wherein two monolithic flexures are used for each of the axes of motion.

5. The multi-axis positioner of claim 1, wherein the fine travel actuation mechanism comprises a voice coil actuator.

6. The multi-axis positioner of claim 1, wherein the coarse travel actuation mechanism comprises a motorized actuator.

7. The multi-axis positioner of claim 1, wherein the coarse travel actuation mechanism comprises a micrometer adjustment screw.

8. The multi-axis positioner of claim 1, further comprising a controller unit configured to control at least one of the coarse travel actuation mechanism and fine travel actuation mechanism.

9. The multi-axis positioner of claim 8, further comprising a feedback mechanism configured to provide position feedback to the controller unit.

10. The multi-axis positioner of claim 9, wherein the feedback mechanism is a closed loop feedback mechanism.

11. The multi-axis positioner of claim 10, wherein the closed loop feedback mechanism is capacitive feedback, strain gauge feedback, optical feedback, magnetic feedback, or electrical resistance feedback.

12. The multi-axis positioner of claim 8, wherein the controller is integrated into the positioner.

13. The multi-axis positioner of claim 8, wherein the controller is a standalone unit external to the positioner.

14. The multi-axis positioner of claim 1, wherein the plurality of axes of motion comprises X, Y and Z-directions.

15. The multi-axis positioner of claim 1, wherein the plurality of axes of motion comprises roll, pitch and yaw.

16. The multi-axis positioner of claim 1, wherein the plurality of axes of motion comprises six axes of motion.
